(19) United States
(12) Patent Application Publication
(10) Pub. No.: US 2023/0047551 A1
(43) Pub. Date: Feb. 16, 2023

(54) HEAT EXCHANGER

(71) Applicant: CiTech Energy Recovery System Malaysia Sdn. Bhd., Klang, Selangor Darul Ehsan (MY)

(72) Inventor: Ian O'Neill, East Yorkshire (GB)

(73) Assignee: CiTech Energy Recovery System Malaysia Sdn. Bhd., Klang, Selangor Darul Ehsan (MY)

(21) Appl. No.: 17/791,823

(22) PCT Filed: Jan. 8, 2021
(86) PCT No.: PCT/MY2021/000001

§ 371 Date: Jul. 8, 2022

(30) Foreign Application Priority Data
Jan. 10, 2020 (MY) PI 2020000188

(51) Int. Cl. F28F 27/02; F28D 7/02; F28D 21/00

(52) U.S. Cl. CPC F28F 27/02; F28D 7/024; F28D 21/0003; F28F 2250/06; F28D 2021/0026

(57) ABSTRACT

A heat exchanger with centric structure for waste heat recovery is disclosed. The heat exchanger (2) includes an annular heat exchange passage (10) with an array of heat exchange pipes located therein and a bypass passage (6) located concentrically within the heat exchange passage. A valve arrangement (40) is provided to switch the flow of exhaust gas between a duty mode and a bypass mode. The valve arrangement comprises a central chamber and a valve plug (96) that is axially movable between a duty position and a bypass position.

### FIELD OF INVENTION

The present teachings relate to heat exchangers for waste heat recovery, for example, to recover waste heat energy from an engine such as a gas turbine engine.

### BACKGROUND

Heat exchangers for the recovery of hot gas exhausted from industrial engines such as gas turbine engines and diesel engines are typically large in design and usually require a large space for installation. To overcome this problem, heat exchangers with concentric structure have been designed.

For instance, European Patent EP1088194 discloses a heat exchanger primarily intended to recover heat from the exhaust gas produced by gas turbines and gas/diesel engines used on offshore platforms and the like.

This patent discloses the general layout of a cylindrical heat exchanger having an annular heat exchange duct with an array of heat exchange pipes located therein and a bypass passage located concentrically within the heat exchange duct. A cylindrical sleeve valve is located between the two ducts and is movable along its axis to switch the flow of exhaust gas between a duty mode in which the gas flows through the heat exchange duct and a bypass mode which, as the name suggests, causes the gas to flow through the bypass passage and therefore not to transfer heat to the array of heat exchange pipes.

This layout has been found to be compact, efficient and safe. In particular, the use of the movable sleeve valve ensures that the flow of exhaust gas can never be blocked, meaning that there is no danger of a back pressure damaging the engine or turbine to which the heat exchange is connected. However, a sleeve valve is generally large and high weight, requiring a heavy-duty lifting system in order to be actuated.

European Patent EP2324318 discloses the use of a multi-louvre damper to control the direction of exhaust gases in the heat recovery process. A typical multi-louvre damper has a complicated actuation system using multiple blades, shafts and linkages which can suffer with high failure rates including high wear.

Additionally, existing cylindrical heat exchangers can suffer from uneven heating of the working fluid inside the array of coils resulting from uneven flow of the exhaust gas coming from the inlet. Heat energy can also be undesirably transferred by convection and radiation from the bypass exhaust gas to the duty passage and into the array. Finally, undesirable heat convection into the duty passage can occur through leakage of exhaust gas at the lower sealing face(s) of the sleeve valve/damper.

The present teachings seek to overcome or at least mitigate one or more of the above problems associated with the prior art.

### SUMMARY OF INVENTION

According to a first aspect of the invention, a heat exchanger is provided comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis; and
a valve arrangement located upstream of the duty and bypass passages to control the proportion of heated gas from the inlet that is directed to the duty and bypass passages,
wherein the valve arrangement comprises:
a central chamber having a first opening in communication with the bypass passage and a second opening in communication with the duty passage; and
a valve plug axially movable between a duty position where the first opening is blocked, and a bypass position where the second opening is blocked.

The heat exchanger inlet location can be easily varied as desired in order to connect to a range of different heated gas inputs. Multiple inlets are also permitted. Additionally, as the valve arrangement is located upstream of the duty and bypass passages, all the mechanical components of the valve arrangement can be easily accessed during repair or maintenance. Further, as the valve arrangement is self-contained and separate from the duty and bypass passages, it can be tested separately before use. Modular construction is also made possible, which is of particular use for construction and transport, as well as enabling the design to be simplified and standardised for multiple installations. The arrangement has also been found to be inherently effective at attenuating noise by virtue of the path the gas takes. Specifically, it has been found that the sudden changes in direction of the flow of gas caused by the valve arrangement of the invention provides good noise attenuation. For example, as the flow of gas is directed around a corner of the valve arrangement, this sudden change of direction results in reduced noise.

In exemplary embodiments, the valve arrangement further comprises an annular gas guide having a radial wall defining the central chamber, the radial wall comprising a plurality of circumferentially distributed radial ports for introducing heated gas into the central chamber.

The circumferentially distributed ports help to even out the flow before it enters the chamber. This helps to increase the flexibility of the heat exchanger, as it is irrelevant what type of heated gas supply it is connected to. Whether it is side entry, bottom entry or both, no extra ducting is needed: the annular gas guide will spread the flow out and ensure it enters in the correct direction. As no extra ducting is needed, the footprint of the heat exchanger and cost of manufacture can be minimised. The annular gas guide of the valve arrangement directs the heated gas flow along a winding path such that noise attenuation benefits are obtained.

In exemplary embodiments, the annular gas guide comprises an axial passage that extends through the annular gas guide, the axial passage being in communication with both the duty passage and the second opening of the chamber in order to guide heated gas from the chamber to the duty passage when the valve plug is in the duty position.

A reduced number of mechanical linkages are required within the heat exchanger that can potentially be damaged or fail. Instead, the annular gas guide remains stationary and performs two functions: guiding heated gas radially into the chamber and guiding heated gas axially into the duty passage when desired. As the gas flow is directed through the axial passage, the direction of gas flow changes substantially as it passes through the annular gas guide, resulting in noise attenuation.

In exemplary embodiments, the chamber is a central chamber and the radial wall of the annular gas guide is a radially inner wall defining the central chamber.

In exemplary embodiments, the annular gas guide further comprises an outer wall spaced from the inner wall, such that the axial passage through the annular gas guide is defined by the outer and inner walls.

The simple construction is easy to manufacture and results in a light component.

In exemplary embodiments, the radial ports pass through the inner wall and the outer wall of the annular gas guide, wherein each radial port is defined by a conduit extending between the inner and outer walls, such that the axial passage is defined by the space between the conduits.

This simple construction enables the annular gas guide to perform two functions, without any complicated mechanical switching arrangements required, simplifying manufacture and significantly reducing the risk of failure of the component.

In exemplary embodiments, the heat exchanger further comprises an annular outer chamber arranged concentrically around the annular gas guide, wherein the annular outer chamber is in communication with the inlet for heated gas such that heated gas passes through the annular outer chamber and into the annular gas guide.

The annular outer chamber further helps to evenly distribute the flow before it passes through the annular gas guide, irrespective of the location of the heated gas inlet.

In exemplary embodiments, the heat exchanger further comprises a manifold located upstream of the valve arrangement, the inlet being located in the manifold and the annular outer chamber being in communication with the manifold, wherein an axial end wall of the central chamber defines a wall of the manifold and is shaped to direct heated gas to the annular outer chamber via vents located in the annular outer chamber.

When the inlet is a bottom entry inlet, the heated gas is simply guided from the inlet in the manifold towards the outer chamber by the outer surface of the central chamber, with no complicated moving parts required.

In exemplary embodiments, the axial end wall of the central chamber has a closeable access aperture in a side wall.

This provides access to the valve arrangement for easy maintenance without having to disassemble the entire heat exchanger.

In exemplary embodiments, the chamber comprises a valve chamber, wherein the first and second openings are defined by the valve chamber.

In exemplary embodiments, the chamber is a central chamber and the valve arrangement further comprises a first valve seat projecting radially inwardly from an inner surface of the valve chamber at the first opening so that valve plug seals against the first valve seat in the duty position.

In exemplary embodiments, the chamber is a central chamber, wherein the valve arrangement further comprises a second valve seat projecting radially inwardly from an inner surface of the valve chamber at the second opening so that valve plug seals against the second valve seat in the bypass position.

In exemplary embodiments, the chamber further comprises a duty chamber.

The different portions of the chamber can perform different functions.

In exemplary embodiments, the second opening is located between the valve chamber and the duty chamber.

In the bypass position, the heated gas is directed downstream into the bypass passage and the seal of the valve plug at the second opening prevents any gas leakage that would eventually flow into the duty passage and transfer heat to the array.

In exemplary embodiments, the first opening is located between the valve chamber and the bypass passage.

As the first opening is sealed in the duty position, the flow direction is reversed and directed towards the second opening and the duty chamber. The reversal of the flow helps to distribute it evenly before it passes axially through the annular gas guide and into the duty passage to transfer heat to the array.

In exemplary embodiments, the duty chamber comprises an opening in communication with the axial passage of the annular gas guide.

In the duty position, heated gas flows from the duty chamber into the axial passage of the annular gas guide and then into the duty passage. When the plug valve is located between the first and second opening, part of the heated gas will pass to the bypass passage and part will pass to the duty passage, i.e. the radial ports are throttled by the valve plug and proportional control of the heated gas flow is possible for an operator.

In exemplary embodiments, the chamber further comprises an actuation chamber, the actuation chamber comprising at least part of an actuation arrangement for actuating the valve plug.

As the actuation arrangement is located in a separate actuation chamber, the risk of it interfering with other components in the heat exchanger is reduced.

In exemplary embodiments, the bottom of the actuation chamber is closed.

Advantageously, any undesirable debris or fluids that falls into the duty and bypass passage is caught in the actuation chamber as there is no direct path through. It can then be safely removed without causing damage to the rest of the heat exchanger, or passing through to the gas inlet. For example, if the gas inlet is connected to a gas turbine, any debris could cause damage to the turbine.

In exemplary embodiments, the actuation chamber comprises a drainage outlet.

This enables any fluids caught in the actuation chamber to be easily drained before they cause damage.

In exemplary embodiments, the duty passage comprises an outlet and the bypass passage comprises an outlet, and the duty passage outlet is separate to the bypass passage outlet.

This helps to prevent heating of the heat exchange array from heated gas that is passed through the bypass passage, as well as allowing the ambient temperature around the heat exchanger to cool the duty passage and heat-exchange array. The overall height of the heat exchanger can also be minimised.

In exemplary embodiments, the bypass outlet is located downstream of the heat exchange array.

This helps to prevent an undesirable backflow at the bypass outlet, where convection can cause some of the heated gas exiting the bypass outlet to transfer heat to the heat exchange array. As the bypass outlet is located downstream of the heat exchange array, this effect is significantly reduced.

In exemplary embodiments, the valve plug comprises a valve disc supported on an axially movable support rod.

This is a single component that can be made low weight, enabling a simple and cost effective lifting mechanism to be used.

In exemplary embodiments, the valve disc is hollow and comprises at least one aperture to expel gas from the valve disc.

The expelled gas acts as ‘sealing gas’, helping to balance the air pressure and prevent air from flowing past the valve disc.

In exemplary embodiments, the chamber is a central chamber, and an outer circumference of the valve disc has an angled surface to engage a surface of the central chamber when in the duty or bypass positions.

The angled surface helps to direct heated gas and define a labyrinth seal. Further, this arrangement negates the need for other, more costly, seal arrangements. For example, louvre arrangements of the prior art use INCONEL® seal tips, which must be replaced every few years. In contrast, the current arrangement has a low initial cost and requires no ongoing maintenance.

In exemplary embodiments, the valve disc comprises two axially spaced walls, with the angled surface being located on a bridging rim connecting the two walls together at the outer circumference of the disc.

The spacing between the walls allows the sealing air to pass through the valve disc. An angled surface can be provided on the upper surface and the lower surface of the bridging rim, to allow a strong seal to be created in the duty and the bypass positions, against a surface of the central chamber.

In exemplary embodiments, the central chamber further comprises a deflector projecting radially inwardly, the deflector being angled and arranged to align with the angled surface of the valve disc to direct heated gas.

The directing of the heated gas helps to reduce the risk of the valve disc being lifted from a valve seat that it seals against in the duty/bypass positions.

In exemplary embodiments, one or both of the two axially spaced walls comprise a curved portion, each curved portion being curved from a radially oriented portion adjacent the outer circumference of the valve disc to an axially oriented portion adjacent the support rod.

The curved axially spaced walls helps to reduce pressure drop within the heat exchanger.

In exemplary embodiments, the support rod comprises a guide rod that engages a guide bracket fixed to the heat exchanger.

The guide rods help to ensure a consistent linear movement of the valve disc.

In exemplary embodiments, the support rod is actuated by a cam and follower arrangement.

A simple cam and follower arrangement actuates the support rod, which is a simple cost-effective arrangement, with a low risk of failure. The support rod can be made light-weight, so low cost actuation, e.g. pneumatic, is possible.

In exemplary embodiments, the cam and follower arrangement comprises a lever driven by an actuator fixed to a rotatable drive shaft, the lever pivotable between first and second positions, wherein rotational movement of the lever is converted to linear motion by a cam that drives a follower fixed to the support rod.

This is a simple and reliable arrangement with a small footprint, to help reduce the size of the heat exchanger. It also allows the drive shaft to be located in a separate chamber, protected from heated gas flow.

In exemplary embodiments, a bracket is fixed to a lower end of the support rod, the bracket comprising a guide slot for guiding the follower.

As the guide slot is below the support rod, it does not get directly heated by the exhaust gases and potentially become damaged in use.

According to a second aspect of the invention, a heat exchanger is provided comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis;
a valve arrangement located upstream of the duty and bypass passages to control the proportion of heated gas from the inlet that is directed to the duty and bypass passages;
a cooling region concentrically located between the duty passage and the bypass passage; and
a cooling gas supply in communication with the cooling region to introduce cooling gas into the cooling region.

The cooling region limits undesirable radiated heat between the duty and bypass passages. If the heating array does not need heating, it is better for no heat energy to be transferred to the array because it would then need to be dissipated somehow, e.g. by using pumps, which is less energy efficient and increases costs.

In exemplary embodiments, the cooling region comprises a cooling gas inlet connected to the cooling gas supply, the cooling gas inlet being configured to introduce cooling gas into the cooling region in an axially offset and at least partially circumferential direction.

This helps to create a ‘cyclone’ of spinning cooling gas, which provides better cooling by more evenly distributing cooling gas around the bypass duct.

In exemplary embodiments, the heat exchanger further comprises a gas diverter arranged around the cooling gas inlet to direct cooling gas into the cooling region in the axially offset and at least partially circumferential direction.

This is a low-cost simple arrangement that diverts the cooling gas in the axially offset and at least partially circumferential direction, consistently and with a low risk of failure.

In exemplary embodiments, a first part of the cooling region is defined by a first wall extending to a downstream end of the heat exchange array and a second wall extending at least partially towards the downstream end of the heat exchange array.

In exemplary embodiments, the second wall terminates before an upstream end of the heat exchange array.

The second wall extends a sufficient axial length to help generate the spinning cooling gas, but then allows the cooling gas to spread out radially through the heat exchange array. This helps to prevent backflow of exhaust gas from the bypass outlet undesirably transferring heat energy to the heat exchange array.

According to a third aspect of the invention, a heat exchanger is provided comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis;
a valve arrangement located upstream of the duty and bypass passages to control the proportion of heated gas from the inlet that is directed to the duty and bypass passages;
an inlet pipe for introducing non-heated gas into the heat exchanger; and
a splitter, arranged in the inlet pipe, to divert the non-heated gas to:
   a sealing path in communication with a sealing arrangement for helping the valve arrangement to create a seal; and/or
   a cooling path in communication with a cooling arrangement for reducing heat transfer between the bypass passage and the duty passage.

With this arrangement, only a single inlet pipe is needed for both sealing and cooling gases, which is a simple arrangement that allows the amount of ‘sealing’ and ‘cooling’ to be easily controlled.

In exemplary embodiments, the splitter is a proportional valve arranged between the sealing and cooling paths.

The proportional valve enables better control of the exact ratio of sealing gas to cooling gas introduced into the heat exchanger.

In exemplary embodiments, the valve arrangement has an outer casing and the proportional valve comprises a valve control located outside the outer casing.

The ratio of gases can be easily controlled from outside the system.

In exemplary embodiments, the inlet pipe comprises first and second ducts, wherein the first duct is arranged concentrically inside the second duct, and the splitter diverts non-heated gas to the first or second duct depending on the amount of sealing or cooling required.

The footprint of the inlet pipe is minimised.

In exemplary embodiments, the second duct is the sealing path, the sealing path being in communication with a valve plug to help the valve plug create a seal with a corresponding valve seat.

In exemplary embodiments, the first duct is the cooling path.

The sealing gas surrounding the cooling duct insulates the cooling gas, helping to keep it cool. This is especially important if the heated gas is introduced through a bottom entry inlet.

In exemplary embodiments, when the valve plug is in the bypass position, the non-heated gas is directed through a hollow support rod of the valve plug and out through at least one aperture in a valve disc of the valve plug.

The sealing gas helps to create a ‘back pressure’ that counteracts the tendency of bypass gas to pass through the valve plug and damage the integrity of the seal.

In exemplary embodiments, the first duct is the cooling path, the first duct being in communication with a cooling region located between the duty passage and the bypass passage.

The cooling region helps reduce undesirable transfer of heat from the bypass passage to the duty passage.

### BRIEF DESCRIPTIONS OF DRAWINGS

FIG. 1A shows an isometric view of a heat exchanger;

FIG. 1B shows an isometric view of the heat exchanger of FIG. 1A from a different angle;

FIG. 2A shows an isometric cross-sectional view of the heat exchanger of FIG. 1A, along the plane 2A-2A, with a plug valve in a first position;

FIG. 2B shows an elevation cross-sectional view of the heat exchanger of FIG. 1A, along the plane 2A-2A, with the plug valve in a first position;

FIG. 3A shows an isometric cross-sectional view of the heat exchanger of FIG. 1A, along the plane 2A-2A, with the plug valve in a second position;

FIG. 3B shows an elevation cross-sectional view of the heat exchanger of FIG. 1A, along the plane 2A-2A, with the plug valve in a second position;

FIG. 4 shows an isometric cross-sectional view of the heat exchanger of FIG. 1A, along the plane 2A-2A, with the plug valve not shown, for clarity;

FIG. 5A shows an isometric view of an alternative heat exchanger, with no side entry inlet;

FIG. 5B shows an elevation cross-sectional view of the heat exchanger of FIG. 5A, along the plane 5B-5B;

FIG. 6A shows an isometric view of an annular gas guide of the heat exchanger of FIG. 1A;

FIG. 6B shows an isometric cross-sectional view of the annular gas guide of FIG. 6A, along the plane 6B-6B;

FIG. 6C shows an isometric cross-sectional view of the annular gas guide of FIG. 6A, along the plane 6C-6C;

FIG. 7A shows an isometric view of the valve plug of the heat exchanger of FIG. 1A;

FIG. 7B shows an elevation cross-sectional view of the valve plug of FIG. 7A, along the plane 7C-7C;

FIG. 7C shows an isometric view of the valve plug of FIG. 7A, from a different angle;

FIG. 8A shows an isometric view of an actuation arrangement of the heat exchanger of FIG. 1A, with the actuation arrangement in a first position;

FIG. 8B shows an isometric cross-sectional view of the actuation arrangement of FIG. 8A, along the plane 8B-8B;

FIG. 8C shows an elevation cross-sectional view of the actuation arrangement of FIG. 8A, along the plane 8B-8B;

FIG. 9A shows an isometric view of the actuation arrangement of the heat exchanger of FIG. 1A, with the actuation arrangement in a second position;

FIG. 9B shows an isometric cross-sectional view of the actuation arrangement of FIG. 9A, along the plane 9B-9B;

FIG. 9C shows an elevation cross-sectional view of the actuation arrangement of FIG. 9A, along the plane 9B-9B;

FIG. 10A shows an isometric view of a cooling gas arrangement of the heat exchanger of FIG. 1A;

FIG. 10B an isometric cross-sectional view of the cooling gas arrangement of FIG. 10A, along the plane 10B-10B;

FIG. 11 shows a close-up isometric view of a lower portion 11 of FIG. 10B; and

FIG. 12 shows an alternative isometric view of FIG. 10A, with further detail of a cooling gas flow.

### DETAILED DESCRIPTION

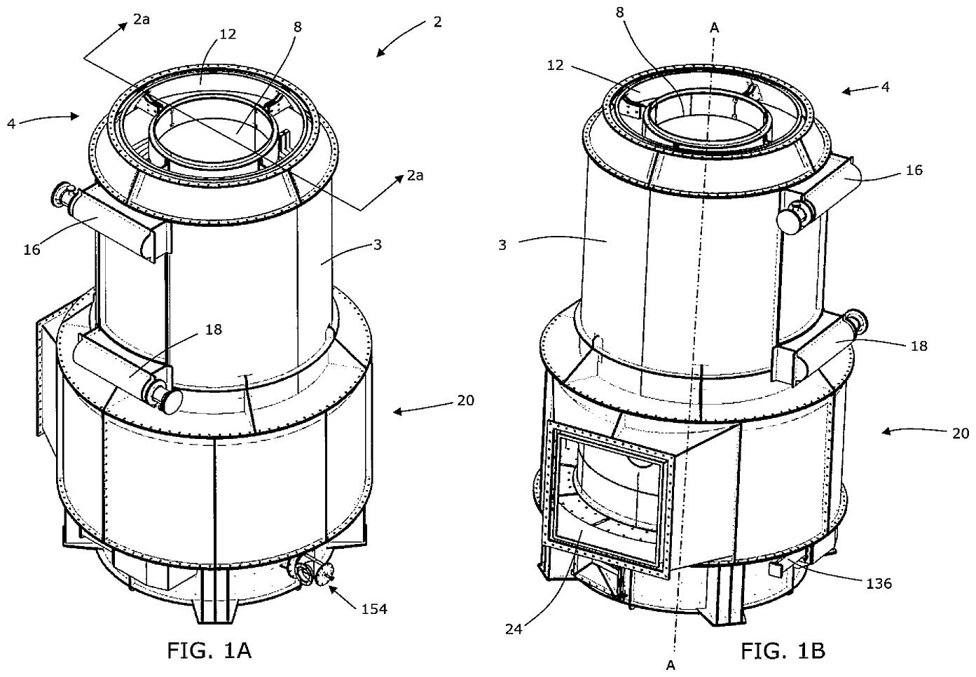

Looking firstly at FIGS. 1A and 1B, a heat exchanger 2 will now be described. In this description, the terms axial, radial, circumferential and tangential are all in relation to an axis A-A which passes longitudinally through the centre of the heat exchanger 2 (see FIG. 1B). The terms upstream and downstream relate to the direction of flow through the heat exchanger 2, with downstream being towards the top of the heat exchanger 2 and upstream being towards the bottom of the heat exchanger 2, when the heat exchanger 2 is in the orientation shown in FIGS. 1A and 1B. However, these directions are for the purposes of description only and should not be construed as limiting; the function of the heat exchanger 2 is independent of its orientation.

The heat exchanger 2 is typically suitable for use as an exhaust gas heat recovery unit in, for example, the offshore oil and gas industries. Such units are typically generally cylindrical in shape and are typically used with their major axis (e.g. axis A-A) orientated vertically. The heat exchanger is generally made up of an upstream inlet arrangement 20, a downstream outlet arrangement 4 and a valve arrangement 40, which will all be described in more detail below.

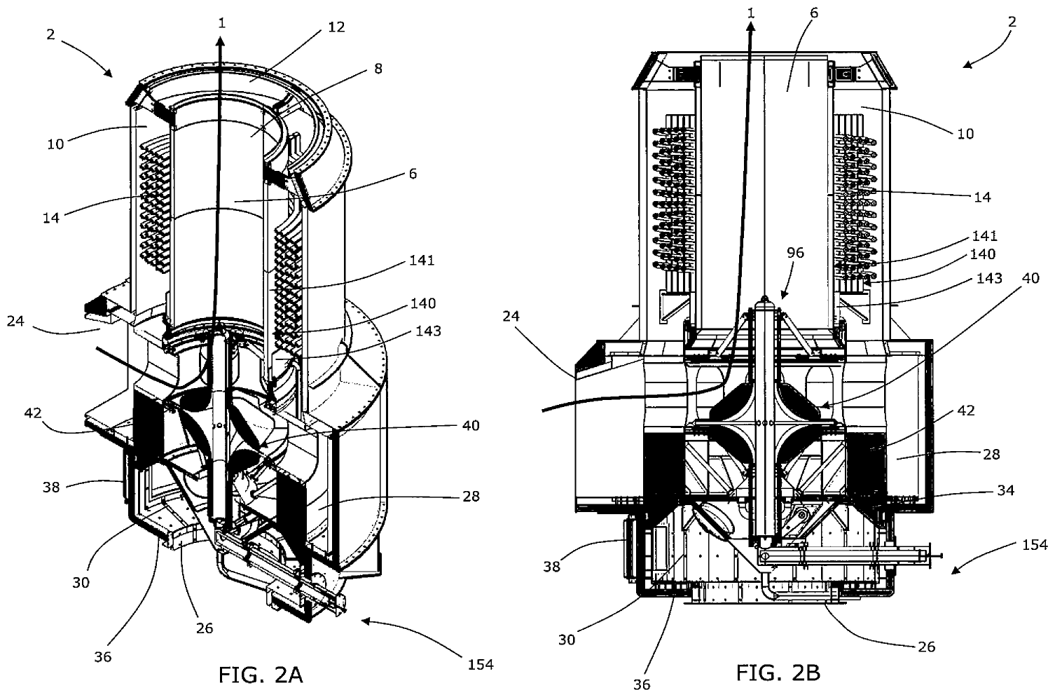

Looking at FIGS. 2A and 2B, the downstream outlet arrangement 4 is surrounded by an outlet casing 3, which is generally cylindrical. The outlet casing 3 defines an outer wall of a duty passage 10. The duty passage 10 is generally annular in shape and extends axially upwardly from the upstream inlet arrangement 20 and the valve arrangement 40. In the duty passage 10 is located a heat exchange array 14, the heat exchange array 14 being held on brackets within the duty passage 10. As can be seen most clearly from FIGS. 1A and 1B, the heat exchange array 14 has a heat exchange array inlet 16 and a heat exchange array outlet 18 which are located outside the outlet casing 3 of the downstream outlet arrangement 4. In this embodiment, working fluid is passed through the heat exchange array inlet 16 and exits from the heat exchange array outlet 18. It will be appreciated, however, that the direction could be reversed if desired, i.e. the heat exchange array inlet 16 could instead be the outlet and the heat exchange array outlet 18 could instead be the inlet. As will be described in more detail below, heat energy is extracted from heated gas that flows through the duty passage 10 into the working fluid, which then exits from the heat exchange array outlet 18 to be utilised as desired.

Concentrically within the duty passage 10 is a bypass passage 6. The bypass passage 6 is a generally cylindrical duct that passes through the centre of the duty passage 10. At the top end of the heat exchanger 2 are a bypass outlet 8 and a duty outlet 12. The bypass outlet 8 is separate from the duty outlet 12. The bypass outlet 8 is located above the heat exchange array 14 so that heated gas exiting the bypass passage 6 through the bypass outlet 8 (as described below) will pass directly to atmosphere, and transfer a minimum of heat energy to the heat exchange array 14.

In general, the function of the heat exchanger 2 is as follows. Heated gas 1 enters the upstream inlet arrangement 20. The heated gas 1 then passes through the valve arrangement 40 where it is directed to either the bypass passage 6 or the duty passage 10. The heated gas 1 then exits the heat exchanger 2 at either the bypass outlet 8 or the duty outlet 12, depending on how the heated gas 1 was directed.

Accordingly, the valve arrangement 40 has a duty position and a bypass position. FIGS. 2A and 2B show the valve arrangement 40 in the bypass position. In the bypass position, the heated gas 1 is directed through the bypass passage 6 and out of the bypass outlet 8, as can be seen by the arrow showing the flow of the heated gas 1. The valve arrangement 40 can also be held at any position between the duty position and the bypass position, to split the heated gas 1 proportionally as desired.

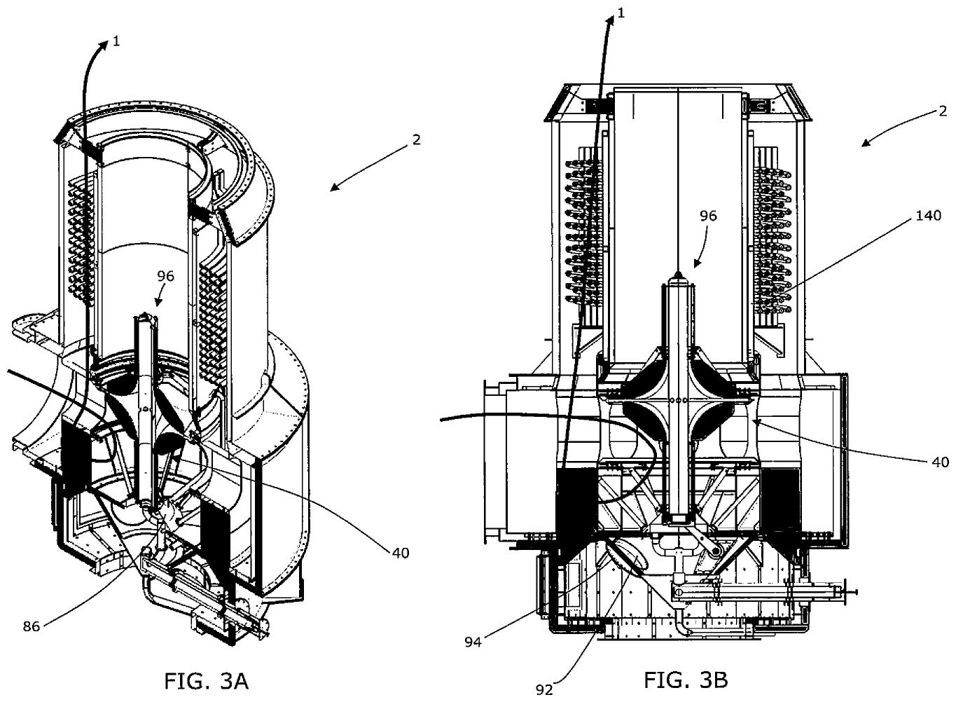

FIGS. 3A and 3B show the valve arrangement 40 in the duty position. In the duty position, the heated gas 1 is directed through the duty passage 10 and out of the duty outlet 12 via the heat exchange array 14, as can be seen by the arrow showing the flow of the heated gas 1.

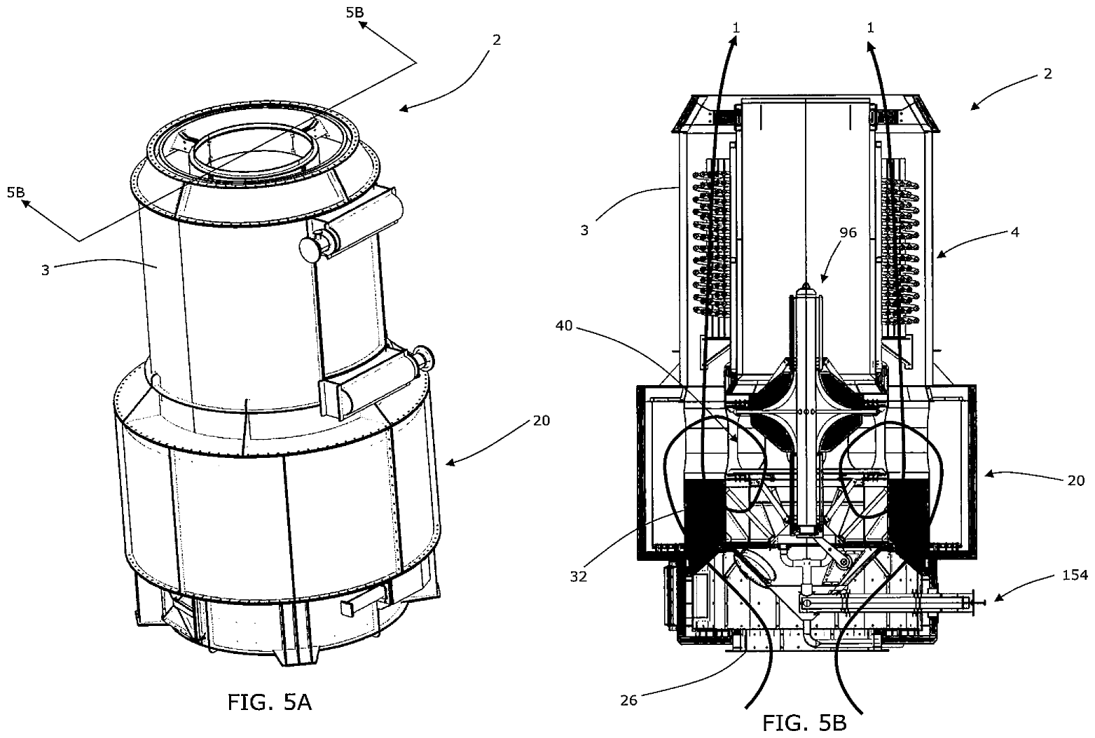

In the arrangement shown in FIGS. 2A to 3B, the heated gas 1 enters through a side entry inlet 24 before passing through the valve arrangement 40, to intersect with axis A-A. In alternative arrangements, e.g. as shown in FIGS. 5A and 5B, the side entry inlet 24 is blocked off or not included in the heat exchanger 2. Instead, the heated gas 1 enters through a bottom entry inlet 26 before passing through the valve arrangement 40. In some arrangements, it may be desired to allow gas to enter through the side entry inlet 24 and the bottom entry inlet 26 simultaneously and/or through multiple side entry inlets 24 simultaneously. This would allow, for example, the heat exchanger 2 to be connected to multiple gas turbines.

The valve arrangement 40 is surrounded by an outer annular chamber 28. The side entry inlet 24 is located in an outer wall of the outer annular chamber 28, so heated gas 1 entering through the side entry inlet 24 passes through the outer annular chamber 28 and into the valve arrangement 40. Below the valve arrangement 40 is a manifold 30. The manifold 30 has mounting brackets 34 for seating the valve arrangement 40 on. A manifold base 36 includes the bottom entry inlet 26. In the arrangement shown in FIG. 5B, the outer annular chamber 28 is in communication with the manifold 30 via vents 32, so heated gas 1 entering through the bottom entry inlet 26 passes though the manifold 30, through the vents 32 into to the outer annular chamber 28 and then into the valve arrangement 40. The manifold 30 also has an access door 38 to enable maintenance or repair.

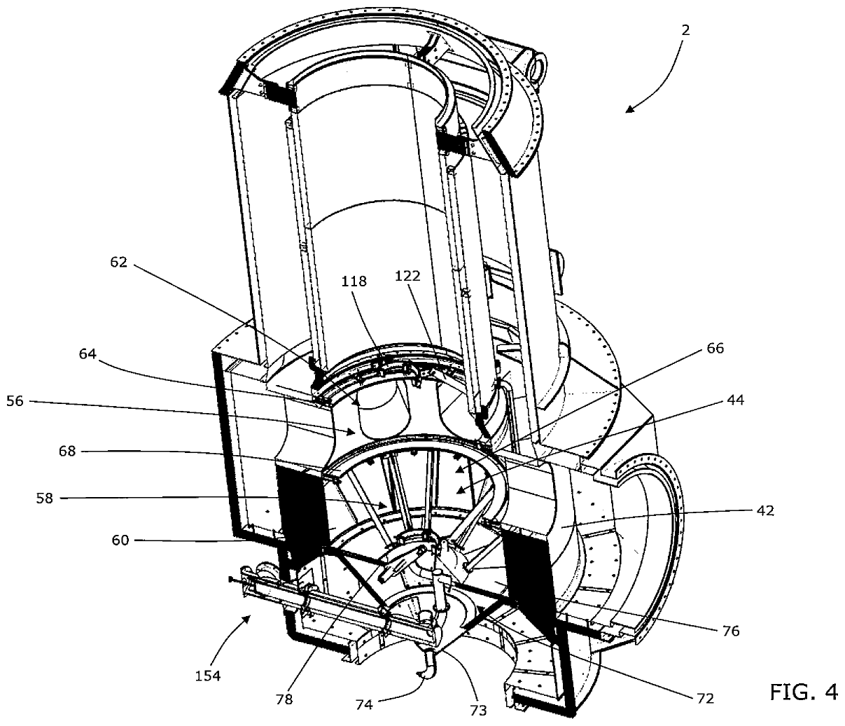

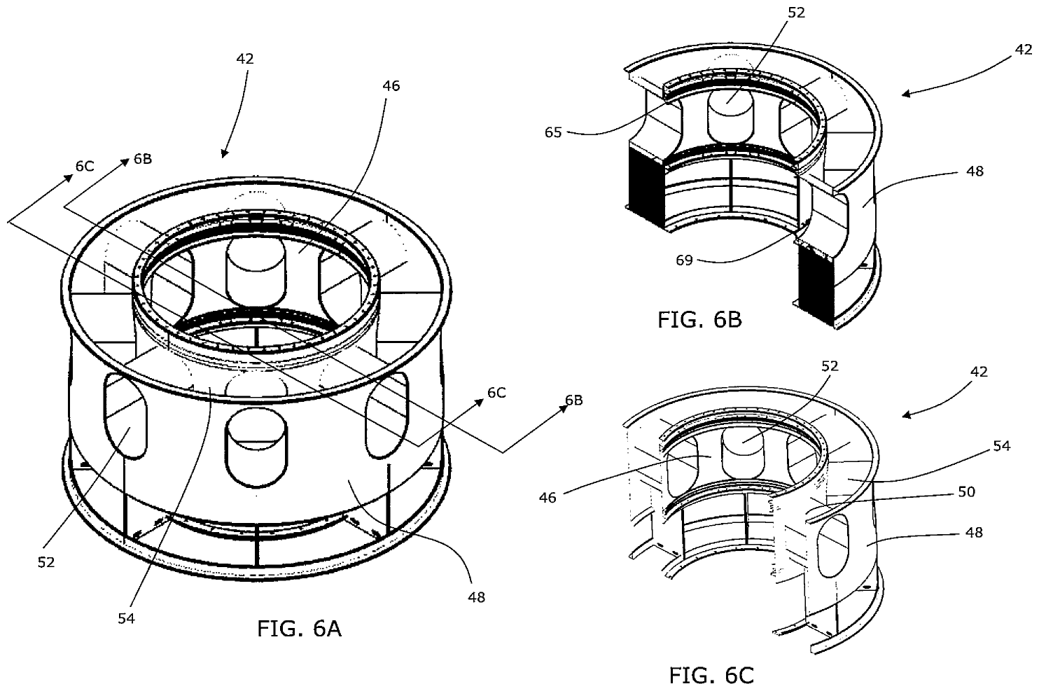

The valve arrangement 40 will now be described in more detail, with reference to FIGS. 6A to 6C. The inner wall of the outer annular chamber 28 is defined by an outer wall 48 of an annular gas guide 42 (see FIG. 2B). The annular gas guide 42 also has an inner wall 46 that defines a central chamber 44 of the valve arrangement 40. The central chamber 44 is made up of three chambers: a valve chamber 56, a duty chamber 58, and an actuation chamber 72 (see FIG. 4).

As shown in more detail in FIGS. 6A to 6C, between the inner wall 46 and the outer wall 48 are a plurality of conduits 50. The radially extending conduits 50 extend in radial direction. In this embodiment, the conduits 50 are eight tubes that are sandwiched between the inner wall 46 and the outer wall 48. In other embodiments, the number of conduits 50 may be varied as required. Each conduit 50 defines a radial inlet port 52 that passes through the inner wall 46 and the outer wall 48. The rest of the space between the inner wall 46 and the outer wall 48 is hollow, such that between the conduits 50 an axial passage 54 is defined. The axial passage 54 is connected at the top end of the annular gas guide 42 to the duty passage 10.

The inner wall 46 of the annular gas guide 42 extends axially for the height of the valve chamber 56 to therefore define the valve chamber 56. At an upper end of the valve chamber 56 is a bypass opening 62 which connects to the bypass passage 6. At the bypass opening 62, a first valve seat 64 projects radially inwardly. The first valve seat 64 is annular. As can be seen most clearly from FIGS. 6B, just below the first valve seat 64 is a first deflector 65. The first deflector 65 is annular and projects from the inner wall 46 of the annular gas guide 42 in a direction that is angled in an axially downward direction, away from the first valve seat 64. The first deflector 65 is arranged between the radial inlet ports 52 and the first valve seat 64, to direct heated gas 1 passing through the radial inlet ports 52 into the valve chamber 56 and away from the first valve seat 64.

The duty chamber 58 is located below the valve chamber 56. At a lower end of the valve chamber 56 is a duty opening 66 which connects to the duty chamber 58. At the duty opening 66, a second valve seat 68 projects radially inwardly. The second valve seat 68 is annular. As can be seen most clearly from FIGS. 6B, just above the second valve seat 68 is a second deflector 69. The second deflector 69 is annular and projects from the inner wall 46 of the annular gas guide 42 in a direction that is angled in an axially upward direction, away from the second valve seat 68. The second deflector 69 is arranged between the radial inlet ports 52 and the second valve seat 68, to direct heated gas 1 passing through the radial inlet ports 52 into the valve chamber 56 and away from the second valve seat 68.

The actuation chamber 72 is located below the duty chamber 58. The duty chamber 58 is separated from the actuation chamber 72 by an annular cover plate 76. The side walls of the duty chamber 58 are defined by duty ramps 60, which extend from the base, which is defined by the annular cover plate 76, to the outer wall 48 of the annular gas guide 42. In effect, this defines a path from the duty chamber 58 to the axial passage 54 of the annular gas guide 42. Therefore, there is a path from the duty chamber 58 through the annular gas guide 42 to the duty passage 10.

The actuation chamber 72 locates a valve actuation arrangement 124, described in more detail below. The actuation chamber 72 is generally conical in shape and tapers down from the annular cover plate 76 to a base 73. The base 73 is relatively narrow compared to the annular cover plate 76. Located in the base 73 is a drainage pipe 74. In the angled side wall is an access aperture 92, with an access aperture cover 94.

The valve arrangement 40 includes a valve plug 96. In the bypass position, the valve plug 96 contacts the second valve seat 68, as shown in FIGS. 2A and 2B. The heated gas 1 therefore flows along the following path: the heated gas 1 enters through the side entry inlet 24, and is distributed through the outer annular chamber 28. The heated gas 1 then enters the radial inlet ports 52 to pass radially through the annular gas guide 42 and into the valve chamber 56. As the duty opening 66 is closed off by the valve plug 96 contacting the second valve seat 68, the heated gas 1 passes through the bypass opening 62 and into the bypass passage 6. The heated gas 1 exits through the bypass outlet 8 without heat energy being transferred to the heat exchange array 14.

In the duty position, the valve plug 96 contacts the first valve seat 64, as shown in FIGS. 3A and 3B. The heated gas 1 therefore flows along the following path: the heated gas 1 enters through the side entry inlet 24, and is distributed through the outer annular chamber 28. The heated gas 1 then enters the radial inlet ports 52 to pass radially through the annular gas guide 42 and into the valve chamber 56. As the bypass opening 62 is closed off by the valve plug 96 contacting the first valve seat 64, the heated gas 1 passes through the duty opening 66 and into the duty chamber 58. From there, the heated gas 1 is guided by the duty ramps 60 into the axial passage 54 of the annular gas guide 42. The heated gas 1 therefore flows axially through the annular gas guide 42 and into the duty passage 10. Heat energy is transferred to the working fluid in the heat exchange array 14 as the heated gas 1 passes past the heat exchange array 14. The heated gas 1 exits through the duty outlet 12.

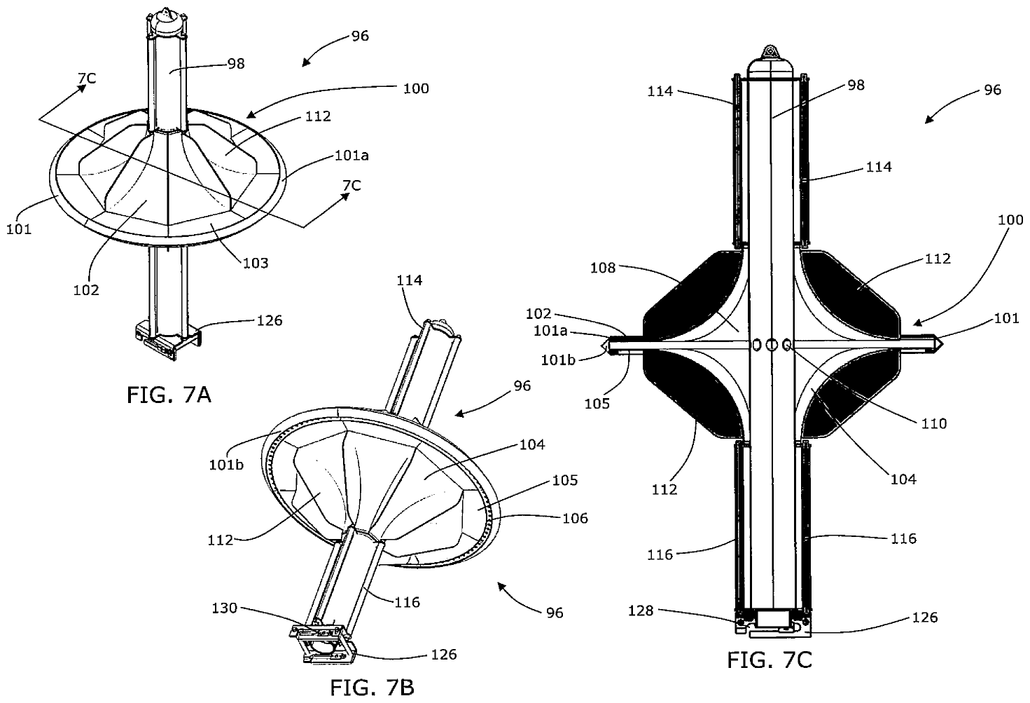

As shown most clearly in FIGS. 7A, 7B and 7C, the valve plug 96 is defined by a valve disc 100 supported on a support rod 98. The support rod 98 is generally elongate and extends in an axial direction. The valve disc 100 is generally made up of a first wall 102, a second wall 104 spaced from the first wall 102.

At the radially outer edge of the first wall 102 is a first wall border 103. The first wall border 103 is annular and substantially planar, extending in a generally horizontal direction perpendicular to the support rod. Similarly, at the radially outer edge of the second wall 104 is a second wall border 105. The second wall border 105 is also annular and substantially planar, extending in a generally horizontal direction perpendicular to the support rod. The remainder of the first wall 102 curves in the axially upward direction to meet the support rod 98. The remainder of the second wall 104 curves in the axially downward direction to meet the support rod 98. In some embodiments, the first wall 102 and the second wall 104 may be made up of a plurality of different portions that are brought together to form the desired shape.

The valve disc 100 also includes an angled bridging portion 101 extending between the radially outer edges of the first wall border 103 and the second wall border 105. The angled bridging portion 101 defines a triangular shape in cross-section, with an upper surface 101a and a lower surface 101b. The upper surface 101a is angled in an axially downward direction from the first wall border 103. The lower surface 101b is angled in an axially upward direction from the second wall border 105. When the valve plug 96 is in the duty position, the lower surface 101b is aligned with the first deflector 65. Together, the lower surface 101b and the first deflector 65 direct heated gas 1 that is entering the valve chamber 56 through the radial inlet ports 52 away from the first valve seat 64. In effect the lower surface 101b and the first deflector 65 act as a labyrinth seal, to help prevent the valve plug 96 from ‘lifting’ away from the first valve seat 64 when the valve plug 96 is in the duty position. When the valve plug 96 is in the bypass position, the upper surface 101a is aligned with the second deflector 69. Together, the upper surface 101a and the second deflector 69 direct heated gas 1 that is entering the valve chamber 56 through the radial inlet ports 52 away from the second valve seat 68. In a similar way to the lower surface 101b and the first deflector 65, the upper surface 101a and the second deflector 69 act as a labyrinth seal, to help prevent the valve plug 96 from ‘lifting’ away from the second valve seat 68 in the bypass position.

A plurality of vanes 112 are also provided on the valve disc 100. Each vane 112 extends in an axial direction from the first wall 102 or the second wall 104. The vanes act to help balance the flow in the valve chamber 56.

The curving and spacing of the first wall 102 and the second wall 104 results in a sealing gas chamber 108 being defined between the first wall 102 and the second wall 104. The support rod 98 is hollow and has sealing gas apertures 110 circumferentially distributed around its outer surface on a part of the support rod 98 that is located in the sealing gas chamber 108. The support rod 98 is in communication with a supply of sealing gas, described in more detail below. The sealing gas is typically air, but any suitable gas can be used. The sealing gas flows up the support rod 98 and out of the sealing gas apertures 110 into the sealing gas chamber 108. The second wall border 105 has a plurality of valve disc apertures 106 circumferentially distributed around the circumference of the second wall 104. From the sealing gas chamber 108, the sealing gas passes out of the valve disc apertures 106, which helps to provide a back-pressure to act against any heated gas 1 that could otherwise undesirably flow past the valve disc 100 due to the pressure of the heated gas 1 in the valve chamber 56.

The support rod 98 includes a first set of guide rails 114 above the valve disc 100 and a second set of guide rails 116 below the valve disc 100. In this embodiment, the first set of guide rails 114 includes four guide rails and the second set of guide rails 116 includes four guide rails, which are all fixed to the support rod 98. As can be seen best in FIG. 4, the valve arrangement 40 includes a first guide bracket 118 and a second guide bracket 120. The first guide bracket 118 is supported on a plurality of support arms 122, which each have one end fixed to the bypass opening 62 and a free end on which the first guide bracket 118 is supported. The first guide bracket 118 is therefore able to actuate axially, along with the support rod 98. The second guide bracket 120 is axially fixed. The first set of guide rails 114 are guided within the first guide bracket 118 and the second set of guide rails 116 are guided within the second guide bracket 120.

At the bottom end of the support rod 98 an actuation bracket 126 is fixed to the support rod 98. The actuation bracket 126 is part of a cam and follower arrangement that converts rotational movement from an actuator into linear movement of the support rod 98.

In this embodiment, the cam and follower arrangement is provided by the actuation bracket 126 having a guide slot 128. The guide slot 128 extends transversely relative to the longitudinal axis of the support rod 98. Within the guide slot 128 is a follower 130. In this embodiment, the follower 130 is made up of two substantially rectangular end caps, each end cap having a height that is greater than the width of the guide slot 128. Such that the follower 130 is retained by the guide slot 128. The end caps fit within the guide slot 128 and can only move in a transverse direction.

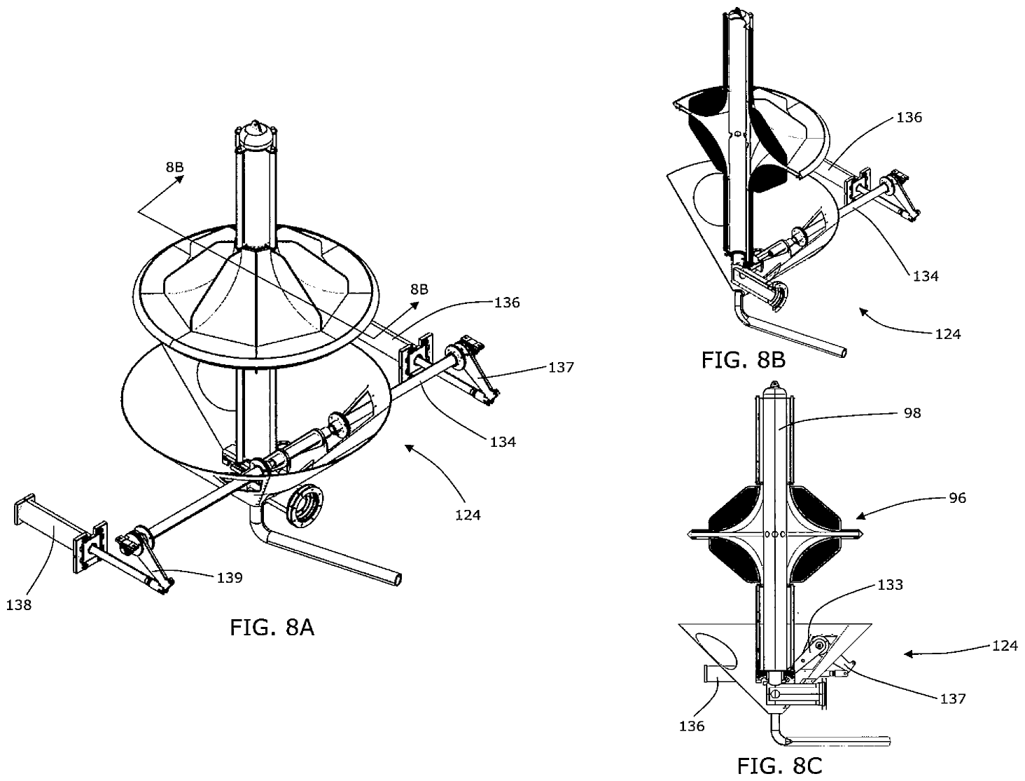

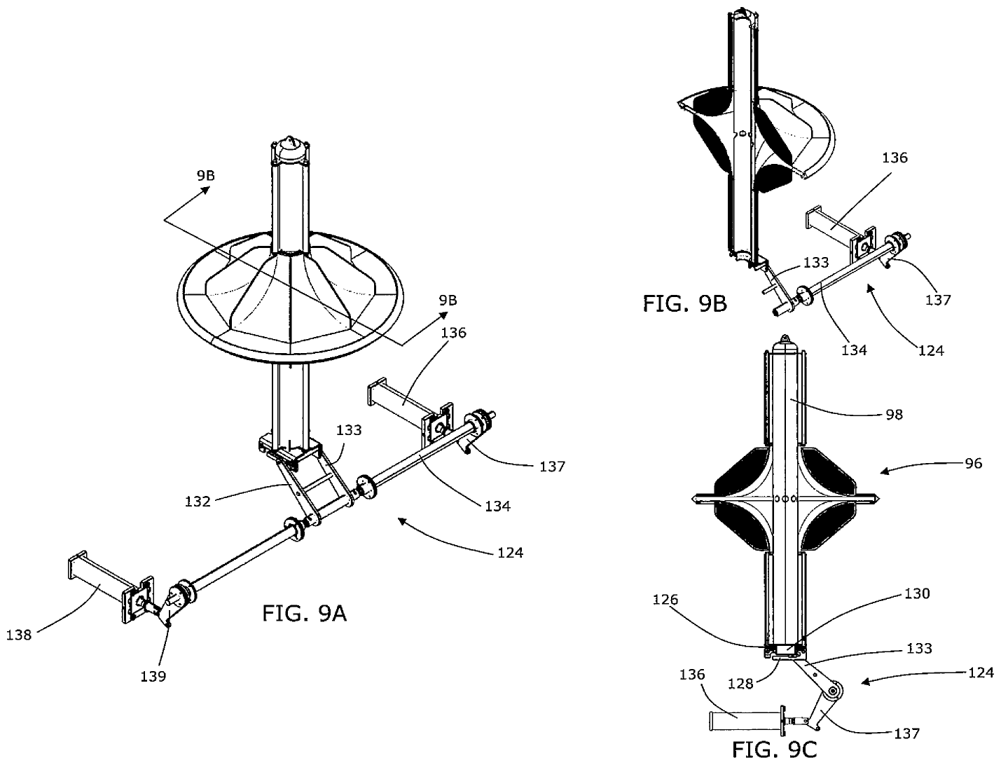

FIGS. 8A to 9C show most clearly how the valve actuation arrangement 124 functions. The valve actuation arrangement 124 is mostly located in the actuation chamber 72 of the valve arrangement 40, so does not interfere with function of the rest of the valve actuation arrangement 124 and can be easily accessed from below for maintenance, i.e. through the access aperture 92.

FIGS. 8A to 8C show the valve plug 96 in the bypass position, where the valve plug 96 is contacting the second valve seat 68. FIGS. 9A to 9C show the valve plug 96 in the duty position where the valve plug 96 is contacting the first valve seat 64.

The valve actuation arrangement 124 includes a first actuator 136 and a second actuator 138. Between the first actuator 136 and the second actuator 138 is a driveshaft 134. In this embodiment, the first actuator 136 and the second actuator 138 are linear reciprocating electric motors. It will be appreciated however, that the first actuator 136 and second actuator 138 could be any suitable type of actuator: for example, hydraulically or pneumatically driven.

The first actuator 136 is connected to the driveshaft 134 via a first actuator lever 137 and the second actuator 138 is connected to the driveshaft 134 via a second actuator lever 139. The first actuator lever 137 and the second actuator 138 convert the linear motion of the first actuator 136 and the second actuator 138 to the rotational movement of the driveshaft 134. In the centre of the driveshaft 134 is a cam configured to contact the follower 130 of the support rod 98. More specifically, the cam is made up of a driven cam first portion 132 and a driven cam second portion 133. The driven cam first portion 132 is fixed to one end of the follower 130 and the driven cam second portion 133 is fixed to the opposite end of the follower 130. This arrangement helps to avoid a clash with a sealing gas input at the bottom end of the support rod 98 (described in more detail below).

Accordingly, as the driveshaft 134 is rotated by the first actuator 136 and the second actuator 138, the driven cam first portion 132 and the driven cam second portion 133 pivot. This pivoting is converted to linear motion by the follower 130 in the guide slot 128, and the support rod 98 being pivoted up and down. As the valve disc 100 is fixed to the support rod 98, this controls the position of the valve plug 96. The valve disc 100 can be moved up to contact the first valve seat 64 or down to contact the second valve seat 68. The valve disc 100 can also be positioned at any position between these two extremes. Accordingly, proportional control of the valve arrangement 40 is possible. For example, if a user wished for 50% of the heated gas 1 flow to pass through the bypass passage 6 and 50% of the heated gas 1 flow to pass through the duty passage 10, this can be easily achieved due to the precise control enabled by the valve actuation arrangement 124.

When the heated gas 1 flow is directed through the bypass passage 6, it is undesirable for heat energy to transfer through to the duty passage 10, as this could heat up the working fluid in the heat exchange array 14, which will then have to be dissipated in some way. In previous designs of heat exchanger, some heat transfer is known to have occurred via radiation from the bypass passage 6 to the duty passage 10. This meant that circulation of the working fluid to a dump cooler was required. Therefore, in this arrangement, a cooling arrangement is provided, to help reduce this heat transfer.

As shown in FIGS. 2A and 2B, a cooling region 140 is provided between the bypass passage 6 and the duty passage 10. The cooling region 140 is annular and extends at least part of the axial length of the bypass passage 6 and the duty passage 10. The cooling region 140 is defined by a first wall 141 extending to a downstream end of the heat exchange array 14 and a second wall 143 extending at least partially towards the downstream end of the heat exchange array 14. In this embodiment, the second wall 143 extends axially such that it terminates just before a region where the heat exchange array 14 is located.

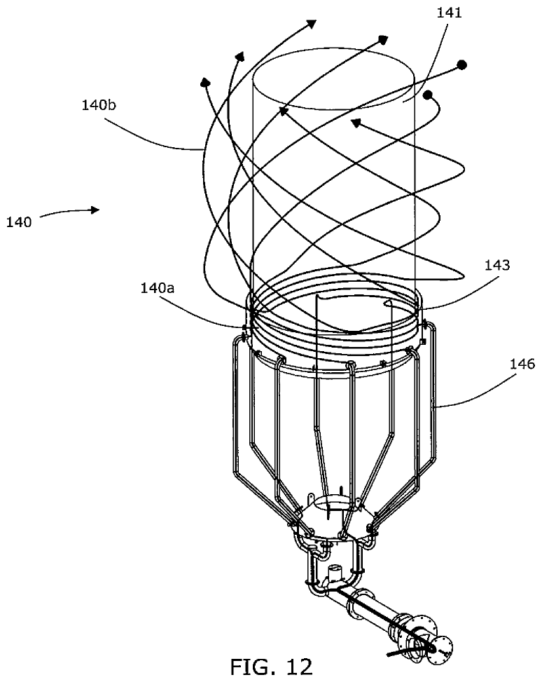

Cooling gas is supplied to the cooling region 140. Normally, the cooling gas is air, but any suitable gas could be used. The cooling gas circulates through the cooling region 140 and exits into the duty passage 10 before then exiting out through the duty outlet 12. As shown most clearly in FIG. 12, the cooling region 140 itself is divided into a first cooling region 140A and a second cooling region 140B. The cooling gas is introduced in a radially inwardly direction into the first cooling region 140A through a plurality of cooling gas entry ports 142 in the second wall 143. In the first cooling region 140A, around each cooling air entry port 142 is a cooling gas deflector 144. Each cooling gas deflector 144 directs the cooling gas in an axially offset and at least partially circumferential direction. In effect, the cooling gas creates a ‘cyclone’ between the second wall 143 and the first wall 141, which is effectively around an outer surface of the bypass passage 6. This cyclone helps evenly mix the cooling gas and create a swirling effect, so that when the cooling gas reaches the end of the second wall 143, it spreads out radially, as shown in FIG. 12. This ‘spread out’ region of flow is the second cooling region 140B. The second cooling region 140B starts just upstream of the heat exchange array 14 and helps to prevent radiation of heat energy from the bypass passage 6 to the heat exchange array 14 in the duty passage 10. Further, the positive pressure created by the cooling gas flow helps to reduce undesirable backflow of the heated gas 1 flow into the duty passage 10 as it exits from the bypass passage 6 through the bypass outlet 8.

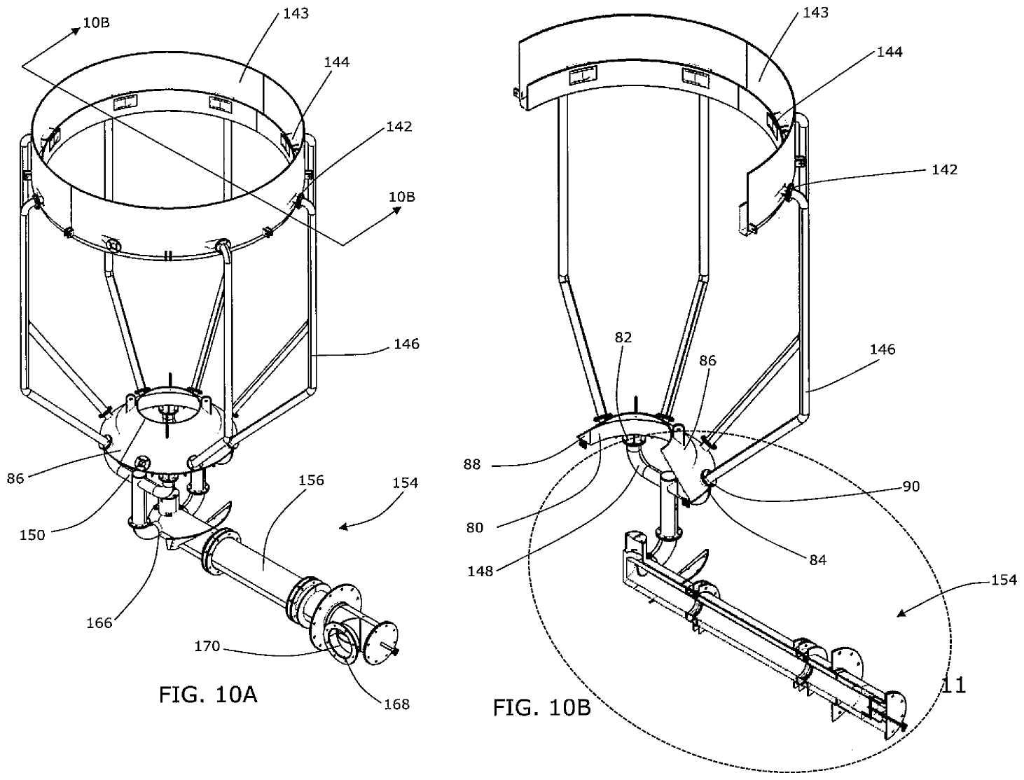

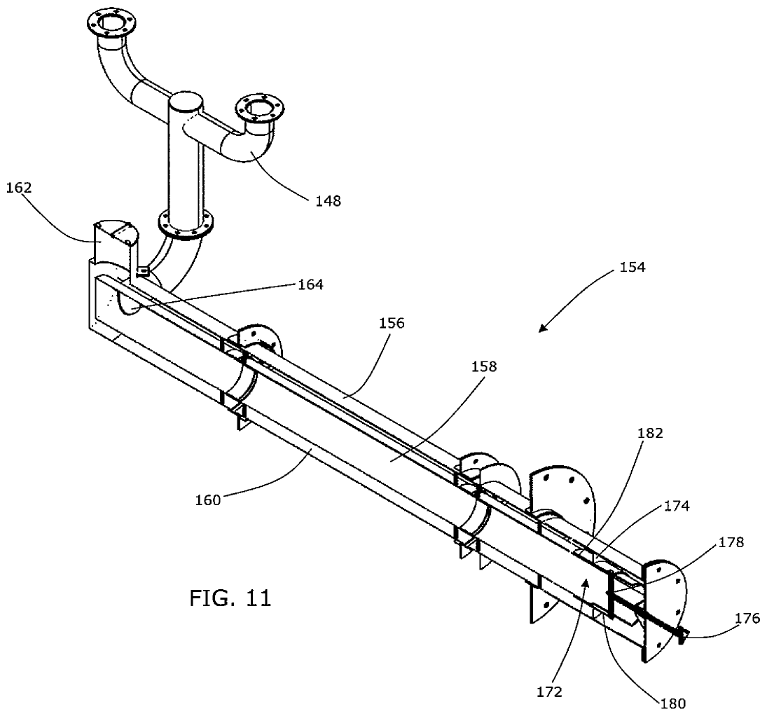

As shown most clearly in FIGS. 10A and 10B, the cooling region 140 is supplied under pressure from a sealing/cooling gas inlet pipe 156. Cooling gas passes from the sealing/cooling gas inlet pipe 156 into a first cooling gas junction 148 and a second cooling gas junction 150, both of which are connected to an annular cooling gas manifold 88 which is located in the actuation chamber 72. The first cooling gas junction 148 and second cooling gas junction 150 are both generally Y-shaped and split a single inlet into two-outlets. The annular cover plate 76 of the actuation chamber 72 comprises a central aperture 78. The main function of the central aperture 78 is to allow the support rod 98 to pass through, so the valve plug 96 can be actuated. Surrounding the central aperture 78 is an axially projecting annular flange 80. A conical cover 86 is arranged over the central aperture 78 and axially projecting annular flange 80. Between the conical cover 86 and the axially projecting annular flange 80 is an annular passage with a triangular cross-section. This annular passage defines the annular cooling gas manifold 88.

The first cooling gas junction 148 and the second cooling gas junction 150 supply cooling gas into the annular cooling gas manifold 88 via a first cooling gas entry bore 82 and a second cooling gas entry bore 84. The cooling gas is then distributed evenly around the annular cooling gas manifold 88. A plurality of cooling gas pipes 146 extend from circumferentially distributed cooling gas exit bores 90 of the annular cooling gas manifold 88. The cooling gas pipes 146 pass through the axial passage 54 of the annular gas guide 42 and each cooling gas pipe 146 connects to one of the cooling gas entry ports 142.

As can be seen, it is necessary to provide a supply of pressurised cooling gas and a supply of pressurised sealing gas. In this arrangement, the cooling gas and sealing gas can both be provided from the sealing/cooling gas inlet arrangement 154.

The sealing/cooling gas inlet arrangement 154 allows precise control by a user of how much gas should be sent to the sealing arrangement and how much gas should be sent to the cooling arrangement.

The sealing/cooling gas inlet arrangement 154 includes a sealing/cooling gas inlet pipe 156. The sealing/cooling gas inlet pipe 156 extends generally radially, through a side wall of the manifold 30, so it can be accessed by a user from outside the heat exchanger 2. The sealing/cooling gas inlet pipe 156 has a cooling gas duct 158 and a sealing gas duct 160. The sealing/cooling gas inlet pipe 156 has a sealing gas duct outlet 162, a first cooling gas duct outlet 164 and a second cooling gas duct outlet 166, but only a single inlet, in the form of a sealing/cooling gas inlet pipe entry opening 168. The sealing/cooling gas inlet pipe entry opening 168 is located on a side surface of the sealing/cooling gas inlet pipe 156. In this embodiment, the sealing/cooling gas inlet pipe entry opening 168 is circular in shape and faces in a direction perpendicular to the longitudinal axis of the sealing/cooling gas inlet pipe 156. The sealing/cooling gas inlet pipe entry opening 168 is surrounded by a flange, so a gas supply can be easily and securely connected.

The sealing/cooling gas inlet pipe entry opening 168 forms a splitter 170 for the gas that enters the sealing/cooling gas inlet pipe 156. In effect, the splitter 170 acts as a proportional valve 172 to control how much of the gas is sent to the cooling gas duct 158 and how much of the gas is sent to the sealing gas duct 160.

Within the sealing/cooling gas inlet pipe 156, the cooling gas duct 158 is arranged concentrically within the sealing gas duct 160. The cooling gas duct 158 has a radially inner end that is closed off. At the closed off radially inner end of the cooling gas duct 158 are the first cooling gas duct outlet 164 and second cooling gas duct outlet 166, which connect to the first cooling gas junction 148 and the second cooling gas junction 150. The radially inner end of the sealing gas duct 160 is in communication with the support rod 98, to pass sealing gas to the sealing gas chamber 108 of the valve disc 100.

The radially outer end of the cooling gas duct 158 is open, and in communication with the sealing/cooling gas inlet pipe entry opening 168. The radially outer end of the sealing gas duct 160 is also in communication with the sealing/cooling gas inlet pipe entry opening 168. At the radially outer end of the sealing/cooling gas inlet pipe 156, a sleeve 182 is arranged on an outer surface of the cooling gas duct 158. The sleeve 182 is free to move in an axial direction along the cooling gas duct 158. The sleeve 182 includes axial grooves 180 engaged by transversely extending arms 178 located inside the cooling gas duct 158. The engagement of the arms 178 and the axial grooves 180 helps to prevent the sleeve 182 from rotating. Further, the arms 178 are connected to a handle 176 that projects from the radially outer end of the sealing/cooling gas inlet pipe 156. The handle 176 extends in a axially longitudinal direction within the cooling gas duct 158. As the handle 176 is reciprocated in an axial direction, due to the connection via the arms 178, the sleeve 182 also reciprocates. Located on the sleeve 182 is an annular blade 174. The annular blade 174 is in the shape of a disc and has an outer diameter that is substantially equal to the inner diameter of the sealing gas duct 160.

Therefore, when the annular blade 174 is moved axially inwardly, more gas entering through the sealing/cooling gas inlet pipe entry opening 168 is directed to the right: i.e. into the open end of the cooling gas duct 158 and out through the first cooling gas duct outlet 164 and the second cooling gas duct outlet 166. When the annular blade 174 is moved axially outwardly, more gas entering though the sealing/cooling gas inlet pipe entry opening 168 is directed to the left: i.e. into the sealing gas duct 160 and out through the sealing gas duct outlet 162. If the valve plug 96 is in the bypass position, an opening in the bottom end of the support rod 98, which is hollow, will connect with the sealing gas duct outlet 162 of the sealing gas duct 160. The sealing gas will be directed to the valve disc apertures 106 via the sealing gas apertures 110 and the sealing gas chamber 108, to help reduce the risk of heated gas 1 leakage from the valve chamber 56. In the duty position, the valve plug 96 will be remote from the sealing gas duct outlet 162 and so no pressurised sealing gas will pass through the support rod 98.

To help ensure a good connection between the support rod 98 and the sealing gas duct outlet 162 and reduce the risk of leakage, an axially slideable inner sleeve 99 is located concentrically within the opening of the support rod 98. The inner sleeve 99 is hollow and allows cooling gas to pass through, between the sealing gas duct outlet 162 and the support rod 98. The inner sleeve 99 is connected to the follower 130 such that as the valve plug 96 is moved by the valve actuation arrangement 124 to the bypass position, the inner sleeve 99 slides axially to locate within the sealing gas duct outlet 162. The valve actuation arrangement 124 is arranged such that, after the valve plug 96 has been moved to the bypass position, there is still play, and the follower 130 will continue to travel. As the follower is in communication with the inner sleeve 99, even when the valve plug 96 is already seated, the inner sleeve 99 will continues to slide axially downward. This helps to ensure there is a good seal between the inner sleeve 99 and the sealing gas duct outlet 162, to reduce the risk of sealing gas leakage.

The sealing gas will be directed to the valve disc apertures 106 via the sealing gas apertures 110 and the sealing gas chamber 108, to help reduce the risk of heated gas 1 leakage from the valve chamber 56. In the duty position, the valve plug 96 will be remote from the sealing gas duct outlet 162 and so no pressurised sealing gas will pass through the support rod 98.

If the annular blade 174 is moved axially inwardly as far as it is permitted to go, 100% of the gas will go to the cooling gas duct 158. If the annular blade 174 is moved axially outwardly as far as it is permitted to go, 100% of the gas will go to the sealing gas duct 160. When the annular blade 174 is at any point between these two extremes, the gas will be split proportionately. Accordingly, from a single input, the cooling gas and the sealing can be controlled, substantially increasing the simplicity of the heat exchanger 2.

The heat exchanger 2 is typically manufactured from carbon steel or stainless steel, but any appropriate material could be used.

In principle a heat exchanger of the type described may be scaled up or down within a wide range of sizes, but the typical mass flow rate of heated gas through the system is between 10 and 120 kg/s when coupled to one or more gas turbines.

It will be appreciated that numerous changes may be made within the scope of the present teachings.

1. A heat exchanger comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis; and
a valve arrangement located upstream of the duty and bypass passages to control the proportion of heated gas from the inlet that is directed to the duty and bypass passages,
wherein the valve arrangement comprises:
a central chamber having a first opening in communication with the bypass passage and a second opening in communication with the duty passage; and
a valve plug axially movable between a duty position where the first opening is blocked, and a bypass position where the second opening is blocked.

2. The heat exchanger of claim 1, wherein the valve arrangement further comprises an annular gas guide having a radial wall defining the central chamber, the radial wall comprising a plurality of circumferentially distributed radial ports for introducing heated gas into the central chamber.

3. The heat exchanger of claim 2, wherein the annular gas guide comprises an axial passage that extends through the annular gas guide, the axial passage being in communication with both the duty passage and the second opening of the chamber in order to guide heated gas from the chamber to the duty passage when the valve plug is in the duty position.

4. The heat exchanger of claim 2, wherein the chamber is a central chamber and the radial wall of the annular gas guide is a radially inner wall defining the central chamber.

5. The heat exchanger of claim 4, wherein the annular gas guide further comprises an outer wall spaced from the inner wall, such that the axial passage through the annular gas guide is defined by the outer and inner walls.

6. The heat exchanger of claim 5, wherein the radial ports pass through the inner wall and the outer wall of the annular gas guide, wherein each radial port is defined by a conduit extending between the inner and outer walls, such that the axial passage is defined by the space between the conduits.

7. The heat exchanger of claim 2, further comprising an annular outer chamber arranged concentrically around the annular gas guide, wherein the annular outer chamber is in communication with the inlet for heated gas such that heated gas passes through the annular outer chamber and into the annular gas guide.

8. The heat exchanger of claim 7, further comprising a manifold located upstream of the valve arrangement, the inlet being located in the manifold and the annular outer chamber being in communication with the manifold, wherein an axial end wall of the central chamber defines a wall of the manifold and is shaped to direct heated gas to the annular outer chamber via vents located in the annular outer chamber.

9. The heat exchanger of claim 8, wherein the axial end wall of the central chamber has a closeable access aperture in a side wall.

10. The heat exchanger of claim 1, wherein the chamber comprises a valve chamber, wherein the first and second openings are defined by the valve chamber.

11. The heat exchanger of claim 10, wherein the chamber is a central chamber, the valve arrangement further comprises a first valve seat projecting radially inwardly from an inner surface of the valve chamber at the first opening so that valve plug seals against the first valve seat in the duty position.

12. The heat exchanger of claim 11, wherein the chamber is a central chamber, wherein the valve arrangement further comprises a second valve seat projecting radially inwardly from an inner surface of the valve chamber at the second opening so that valve plug seals against the second valve seat in the bypass position.

13. The heat exchanger of claim 10, wherein the chamber further comprises a duty chamber.

14. The heat exchanger of claim 13, wherein the second opening is located between the valve chamber and the duty chamber.

15. The heat exchanger of claim 13, wherein the first opening is located between the valve chamber and the bypass passage.

16. The heat exchanger of claim 9 with proviso that when the annular gas guide comprises an axial passage that extends through the annular gas guide, the axial passage being in communication with both the duty passage and the second opening of the chamber in order to guide heated gas from the chamber to the duty passage when the valve plug is in the duty position, the duty chamber comprises an opening in communication with the axial passage of the annular gas guide.

17. The heat exchanger of claim 10, wherein the chamber further comprises an actuation chamber, the actuation chamber comprising at least part of an actuation arrangement for actuating the valve plug.

18. The heat exchanger of claim 17, wherein the bottom of the actuation chamber is closed.

19. The heat exchanger of claim 18, wherein the actuation chamber comprises a drainage outlet.

20. The heat exchanger of claim 1, wherein the duty passage comprises an outlet and the bypass passage comprises an outlet, and the duty passage outlet is separate to the bypass passage outlet.

21. The heat exchanger of claim 20, wherein the bypass outlet is located downstream of the heat exchange array.

22. The heat exchanger of claim 1, wherein the valve plug comprises a valve disc supported on an axially movable support rod.

23. The heat exchanger of claim 22, wherein the valve disc is hollow and comprises at least one aperture to expel gas from the valve disc.

24. The heat exchanger of claim 22, wherein the chamber is a central chamber, and an outer circumference of the valve disc has an angled surface to engage a surface of the central chamber when in the duty or bypass positions.

25. The heat exchanger of claim 24, wherein the valve disc comprises two axially spaced walls, with the angled surface being located on a bridging rim connecting the two walls together at the outer circumference of the disc.

26. The heat exchanger of claim 24, wherein the central chamber further comprises a deflector projecting radially inwardly, the deflector being angled and arranged to align with the angled surface of the valve disc to direct heated gas.

27. The heat exchanger of claim 25, wherein one or both of the two axially spaced walls comprise a curved portion, each curved portion being curved from a radially oriented portion adjacent the outer circumference of the valve disc to an axially oriented portion adjacent the support rod.

28. The heat exchanger of claim 22, wherein the support rod comprises a guide rod that engages a guide bracket fixed to the heat exchanger.

29. The heat exchanger of claim 22, wherein the support rod is actuated by a cam and follower arrangement.

30. The heat exchanger of claim 29, wherein the cam and follower arrangement comprises a lever driven by an actuator fixed to a rotatable drive shaft, the lever pivotable between first and second positions, wherein rotational movement of the lever is converted to linear motion by a cam that drives a follower fixed to the support rod.

31. The heat exchanger of claim 30 wherein a bracket is fixed to a lower end of the support rod, the bracket comprising a guide slot for guiding the follower.

32. A heat exchanger comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis;
a valve arrangement located upstream of the duty and bypass passages to control the proportion of heated gas from the inlet that is directed to the duty and bypass passages;
a cooling region concentrically located between the duty passage and the bypass passage; and
a cooling gas supply in communication with the cooling region to introduce cooling gas into the cooling region.

33. The heat exchanger of claim 32, wherein the cooling region comprises a cooling gas inlet connected to the cooling gas supply, the cooling gas inlet being configured to introduce cooling gas into the cooling region in an axially offset and at least partially circumferential direction.

34. The heat exchanger of claim 33 further comprising a gas diverter arranged around the cooling gas inlet to direct cooling gas into the cooling region in the axially offset and at least partially circumferential direction.

35. The heat exchanger of claim 34, wherein a first part of the cooling region is defined by a first wall extending to a downstream end of the heat exchange array and a second wall extending at least partially towards the downstream end of the heat exchange array.

36. The heat exchanger of claim 35, wherein the second wall terminates before an upstream end of the heat exchange array.

37. A heat exchanger comprising:
an inlet for introducing heated gas;
a duty passage having a heat exchange array to permit a transfer of heat energy to a working fluid in the heat exchange array as heated gas passes through the duty passage;
a bypass passage for ejecting heated gas to atmosphere, wherein the duty passage and bypass passage are concentrically arranged with respect to one another and define an axis;
a valve arrangement located upstream of the duty and bypass passages to control the proportion of heated gas from the inlet that is directed to the duty and bypass passages;
an inlet pipe for introducing non-heated gas into the heat exchanger; and
a splitter, arranged in the inlet pipe, to divert the non-heated gas to:
a sealing path in communication with a sealing arrangement for helping the valve arrangement to create a seal; and/or
a cooling path in communication with a cooling arrangement for reducing heat transfer between the bypass passage and the duty passage.

38. The heat exchanger of claim 37, wherein the splitter is a proportional valve arranged between the sealing and cooling paths.

39. The heat exchanger of claim 38, wherein the valve arrangement has an outer casing and the proportional valve comprises a valve control located outside the outer casing

40. The heat exchanger of claim 37, wherein the inlet pipe comprises first and second ducts, wherein the first duct is arranged concentrically inside the second duct, and the splitter diverts non-heated gas to the first or second duct depending on the amount of sealing or cooling required.

41. The heat exchanger of claim 40, wherein the second duct is the sealing path, the sealing path being in communication with a valve plug to help the valve plug create a seal with a corresponding valve seat.

42. The heat exchanger of claim 41, wherein the first duct is the cooling path.

43. The heat exchanger of claim 41, wherein, when the valve plug is in the bypass position, the non-heated gas is directed through a hollow support rod of the valve plug and out through at least one aperture in a valve disc of the valve plug.

44. The heat exchanger of claim 37, wherein the first duct is the cooling path, the first duct being in communication with a cooling region located between the duty passage and the bypass passage.
